(19) United States
(12) Patent Application Publication
(10) Pub. No.: US 2026/0223149 A1
(43) Pub. Date: Jul. 30, 2026

(54) INDICATING PAYLOAD TO RECIPIENT WIRELESS COMMUNICATION DEVICE

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Huilin XU, Temecula, CA (US); Zhikun WU, Beijing (CN); Linhai HE, San Diego, CA (US); Yuchul KIM, San Diego, CA (US); Wei YANG, San Diego, CA (US); Wanshi CHEN, San Diego, CA (US); Peter GAAL, San Diego, CA (US)

(21) Appl. No.: 19/146,756

(22) PCT Filed: Feb. 24, 2023
(86) PCT No.: PCT/CN2023/078060

§ 371 Date: Jul. 9, 2025

(51) Int. Cl. H04W 72/51; H04W 72/1273

(52) U.S. Cl. CPC H04W 72/51; H04W 72/1273

(57) ABSTRACT

Various aspects of the present disclosure generally relate to wireless communication. In some aspects, a first wireless communication device may transmit, to a second wireless communication device, information indicating at least one of: data for a third wireless communication device, or one or more transmission parameters of the data for the third wireless communication device. The first wireless communication device may transmit, to the second wireless communication device, a payload that is modulated with the data for the third wireless communication device. Numerous other aspects are described.

### FIELD OF THE DISCLOSURE

Aspects of the present disclosure generally relate to wireless communication and to techniques and apparatuses for indicating a payload to a recipient wireless communication device.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a first wireless communication device. The method may include transmitting, to a second wireless communication device, information indicating at least one of: data for a third wireless communication device, one or more transmission parameters of the data for the third wireless communication device. The method may include transmitting, to the second wireless communication device, a payload that is modulated with the data for the third wireless communication device.

Some aspects described herein relate to a method of wireless communication performed by a second wireless communication device. The method may include receiving, from a first wireless communication device, information indicating at least one of, data for a third wireless communication device, or one or more transmission parameters of the data for the third wireless communication device. The method may include receiving, from the first wireless communication device, a payload that is modulated with the data for the third wireless communication device.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station and user equipment (UE), in accordance with the present disclosure.

FIG. 3 depicts an example disaggregated base station architecture.

FIGS. 4A, 4B, 4C, and 4D depict aspects of data structures for a wireless communications network, in accordance with the present disclosure.

FIG. 5 is a diagram illustrating an example of a low-power wakeup receiver (LP-WUR) and a low-power wakeup signal (LP-WUS), in accordance with the present disclosure.

FIG. 6 is a diagram illustrating an example of a first wireless communication device communicating with a second wireless communication device and a third wireless communication device, in accordance with the present disclosure.

FIG. 7 is a diagram illustrating an example of signaling associated with indication of a passive device data transmission to a wireless communication device, in accordance with the present disclosure.

FIG. 8 shows a method for wireless communications by a UE.

FIG. 9 shows a method for wireless communications by a UE.

FIG. 10 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for indicating a payload (such as for a passive Internet of Things (IoT) device) to a recipient wireless communication device (such as a device other than the passive IoT device).

In various wireless communication networks, various client devices can be utilized that may be associated with different signaling and communication capabilities. For example, as 5G networks expand into industrial verticals and the quantity of deployed IoT devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, ultra-light IoT devices, etc.

For example, passive IoT devices and semi-passive IoT devices are relatively low-cost user equipments (UEs) that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. Passive and semi-passive IoT devices can include one or more sensors, a processor or micro-controller, and an energy harvester for generating electrical power from incident downlink radio frequency (RF) signals received at the passive or semi-passive IoT device.

Based on harvesting energy from incident downlink RF signals (e.g., transmitted by a network device such as a base station, gNB, etc.), energy harvesting devices (e.g., passive IoT devices, semi-passive IoT devices) can be provided without an energy storage element and/or can be provided with a relatively small energy storage element (e.g., battery, capacitor, etc.). Energy harvesting devices can be deployed on large scales, based on the simplification in their manufacture and deployment associated with implementing wireless energy harvesting (e.g., relative to an eMBB UE).

In a wireless communication network environment (e.g., cellular network, etc.), a network device (e.g., a base station or gNB) can be used to transmit downlink RF signals to energy harvesting devices. In one illustrative example, a base station or gNB can read and/or write information stored on energy harvesting IoT devices by transmitting the downlink RF signal. A downlink RF signal can provide energy to an energy harvesting IoT device and can be used as the basis for an information-bearing uplink signal transmitted back to the network device (or to another receiver) by the energy harvesting IoT device (e.g., based on reflecting or backscattering a portion of the incident downlink RF signal). The base station or gNB can read the reflected signal transmitted by the energy harvesting IoT device to decode the information transmitted by the IoT device (e.g., sensor information collected by one or more sensors included in the IoT device).

In some examples, for a given downlink signal with a given input RF power received at an energy harvesting device, a first portion of the input RF power is provided to the device's energy harvester (e.g., with a percentage being converted to useful electrical power based on the conversion efficiency of the harvester, and the remaining percentage wasted or dissipated as heat). A remaining, second portion of the input RF power is available for use in the backscattered uplink transmission (e.g., the second portion of the input power is reflected and modulated with the uplink communication).

Ultra-light IoT devices can include both a backscatter transmitter (e.g., a backscatter radio) and an active transmitter (e.g., an active radio). A backscatter transmitter can generate and transmit an uplink signal by reflecting and backscatter modulating an incident downlink signal. In some examples, an ultra-light IoT device can use a backscatter transmitter that is the same as or similar to a backscatter transmitter utilized by a passive or semi-passive IoT device. An active transmitter can use a battery or other energy storage element included in the ultra-light IoT device to generate and transmit an uplink signal. To transmit an uplink signal, the backscatter transmitter of an ultra-light IoT device must first receive a downlink signal that can be reflected and backscatter modulated. For example, the backscatter transmitter may be unable to transmit an uplink signal unless or until a continuous sine wave is received as a downlink signal from a base station, gNB, or other network device. The active transmitter of an ultra-light IoT device can perform uplink communication that is triggered by the ultra-light IoT device (e.g., without dependence on first receiving a downlink signal).

An ultra-light IoT device may include only a small battery or energy storage element and may not sustain longer periods of uplink communication using the active transmitter of the ultra-light IoT device. For example, active transmission by an ultra-light IoT device may quickly deplete the onboard battery or other energy storage element(s) included in the ultra-light IoT device.

In some situations, passive devices (e.g., ultra-light IoT devices, passive IoT devices, semi-passive IoT devices, etc.) may coexist with UEs in a wireless network. It may be beneficial to combine transmission of data for passive devices with transmission of data (e.g., a payload) for other UEs. For example, a first signal (destined to a UE) and a second signal (destined to a passive device) may both carry data for the passive device, thereby achieving improved utilization of the spectrum relative to transmitting the first signal and the second signal separately from one another. The UE may need to decode the data for the UE. However, the first signal received by the UE may be modulated with data for the passive device. Without information indicating the data for the passive device, the UE may have to perform costly and resource-intensive techniques to decode the data for the UE, or may be unable to decode the data for the UE. Thus, resource utilization is degraded and efficiency of communication is decreased.

Some techniques described herein provide signaling, from a first wireless communication device to a second wireless communication device (e.g., a UE), of the data for a third wireless communication device (e.g., a passive device). Thus, the second wireless communication device can use the data for the third wireless communication device to decode data directed to the second wireless communication device and modulated with the data for the third wireless communication device, such as by canceling the modulated data for the third wireless communication device. In this way, resource utilization is improved and efficiency of communication is improved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

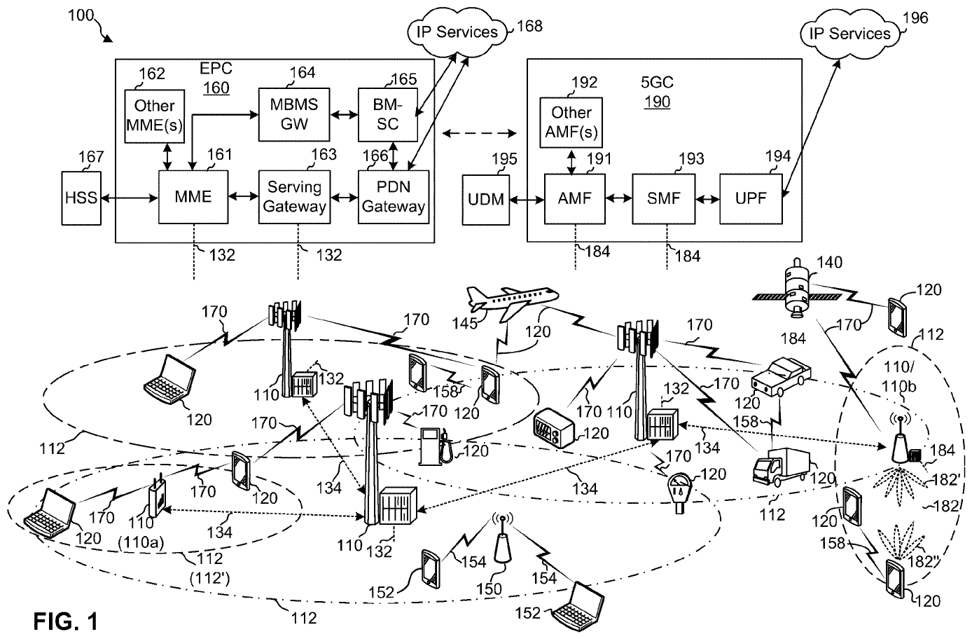

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an IoT device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

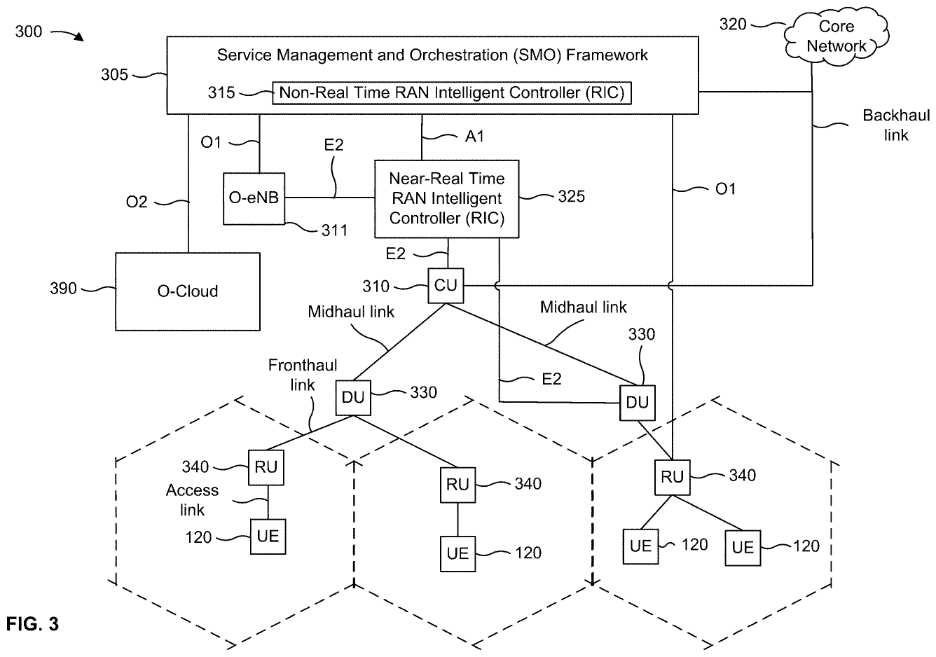

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open radio access network (RAN) (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, the 3rd Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

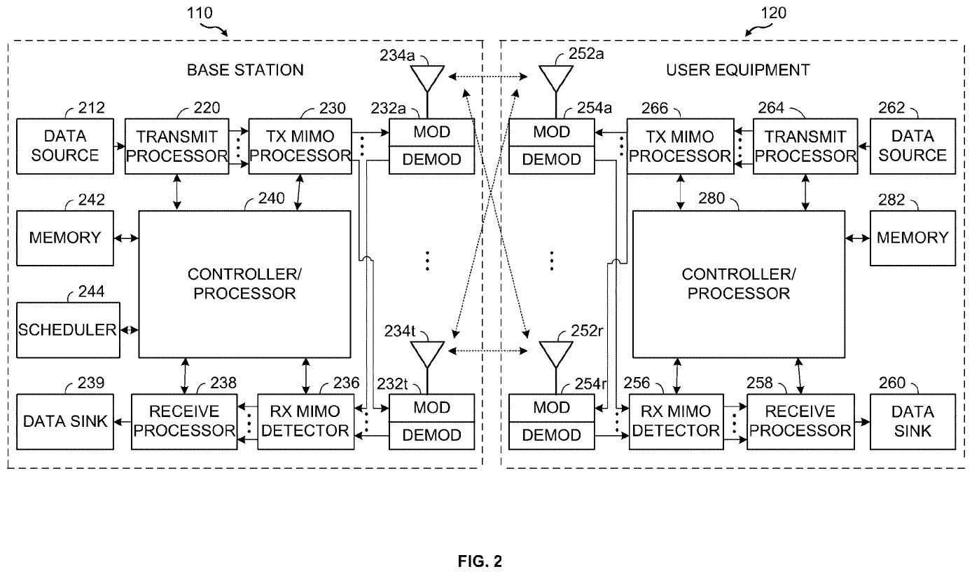

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, receive (RX) MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more RF access links. In some implementations, the UE 120 may be simultaneously served by multiple RUs 340.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

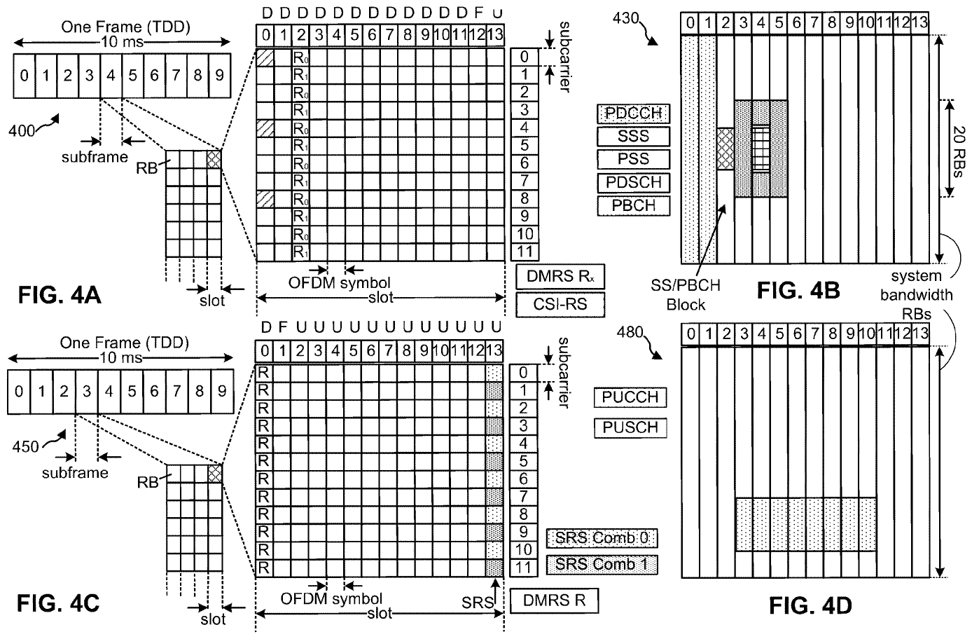

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex, in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2^{μ} slots/subframe. The subcarrier spacing and symbol length/duration are a function of the numerology. The subcarrier spacing may be equal to 2^{μ}×15 kHz, where g is the numerology index, which may be selected from values 0 to 5. Accordingly, the numerology ρ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (also referred to as an SS block (SSB)). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgement (ACK) or negative ACK (NACK) (ACK/NACK) feedback. The PUSCH carries data, and may additionally be used to carry a buffer status report (BSR), a power headroom report (PHR), and/or UCI.

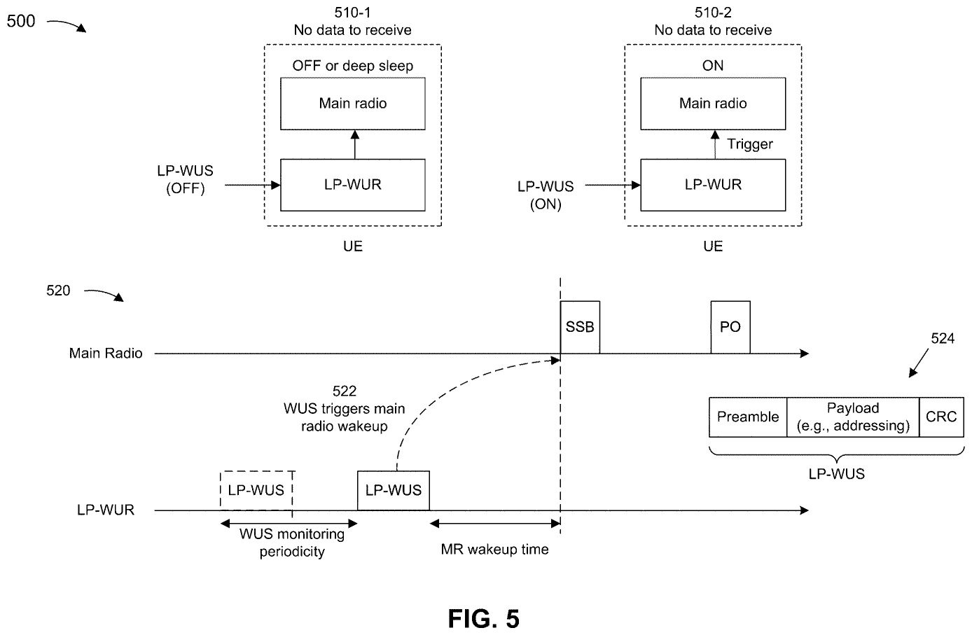

FIG. 5 is a diagram illustrating an example 500 of a low-power wakeup receiver (LP-WUR) and a low-power wakeup signal (LP-WUS), in accordance with the present disclosure. As shown in FIG. 5, a UE may be equipped with a communication system that includes a main radio (MR) and an LP-WUR to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 5, the UE may be equipped with the LP-WUR, which is a companion receiver that may be used with a main radio to reduce power consumption and latency.

For example, in some aspects, the UE may generally use the main radio to transmit and/or receive user data, and the main radio may be turned off or operated in a deep sleep state (e.g., a power state associated with one (1) relative power unit, as defined in TR 38.840) unless there is user data to transmit and/or receive. Furthermore, the LP-WUR may serve as a simple wakeup receiver for the main radio (e.g., the LP-WUR does not include a transmitter), and the LP-WUR may be active and monitoring for an LP-WUS while the main radio is off or in the deep sleep state or ultra-low power/sleep state. For example, reference number 510-1 depicts a first state associated with the main radio and the LP-WUR where there is no user data that the main radio needs to receive. In such cases, the main radio may be off or operated in the deep sleep state unless there is user data to transmit, and the LP-WUR may actively monitor for an LP-WUS (e.g., continuously or periodically in monitoring occasions that are separated in time). Furthermore, reference number 510-2 depicts a second state associated with the main radio and the LP-WUR where there is user data that the main radio needs to receive. In such cases, the LP-WUR may receive an LP-WUS (e.g., from a network node) and may provide a trigger to wake or otherwise activate the main radio based on detecting the LP-WUS. Accordingly, the main radio may then transmit and/or receive user data.

In general, the LP-WUR may consume very little power, which may be achieved using simple modulation schemes (e.g., on-off-keying (OOK)), a narrow bandwidth (e.g., less than 5 MHz or 20 MHz), and/or other suitable techniques. In this way, the LP-WUR can be used to reduce the time that the main radio spends in an on state and/or may avoid unnecessarily waking the main radio from the off or deep sleep state when there is no user data to transmit or receive, which tends to be costly from a power consumption perspective. Furthermore, because the LP-WUR has a very low power consumption, the LP-WUR can be used to frequently or continuously perform LP-WUS monitoring, which may improve latency because the main radio can be woken up when there is user data that the main radio needs to receive (e.g., the LP-WUR does not suffer from the latency versus power efficiency tradeoff associated with duty cycling schemes, such as discontinuous reception (DRX)). Furthermore, in addition to performing LP-WUS monitoring, which is mainly targeted at paging reception, the LP-WUR may monitor a low power reference signal (LP-RS) for time and frequency tracking and radio resource management (RRM) measurement. In this way, by monitoring the LP-RS, serving cell and/or neighbor cell monitoring can be offloaded from the main radio to the LP-WUR to reduce how often the main radio is woken up, which can further reduce power consumption.

In some aspects, as shown by reference number 520, one application the LP-WUR is to monitor the LP-WUS for paging monitoring, which can be used to reduce unnecessary paging reception performed by the main radio. For example, as shown in FIG. 5, the LP-WUR may be configured to monitor for an LP-WUS (e.g., while the main radio is off or in a deep sleep state) according to a WUS monitoring periodicity (e.g., the LP-WUR may monitor for the LP-WUS in periodic LP-WUS monitoring occasions that are separated in time by the WUS monitoring periodicity). Alternatively, although not explicitly shown in FIG. 5, the LP-WUR may be configured to continuously monitor for the LP-WUS. In general, a network node may transmit an LP-WUS to a UE only in cases where there is a paging message that needs to be sent to the UE while the UE is in an idle or inactive state (e.g., an RRC idle or RRC inactive state). In such cases, as shown by reference number 522, the LP-WUR may receive and detect the LP-WUS, which may trigger the LP-WUR to wake up the main radio. For example, as shown by reference number 524, the LP-WUS may be a message-based WUS, which may correspond to a packet that includes a preamble, a payload (e.g., a cell identifier or UE addressing for a paging early indication), and a cyclic redundancy code (CRC). Alternatively, in some aspects, the LP-WUS may be a sequence-based WUS, which may include a predefined set of sequences that depend on a cell identifier and/or an identifier associated with the UE. In either case, as shown, the main radio may wake up after a main radio wakeup time, and may then start to monitor one or more SSB transmissions to obtain synchronization with the network node before monitoring and receiving the paging message in a subsequent paging occasion (PO). Otherwise, in cases where the LP-WUR does not detect the LP-WUS, the main radio may remain in the deep sleep state to save power.

As indicated above, FIG. 5 is provided as an example. Other examples may differ from what is described with regard to FIG. 5.

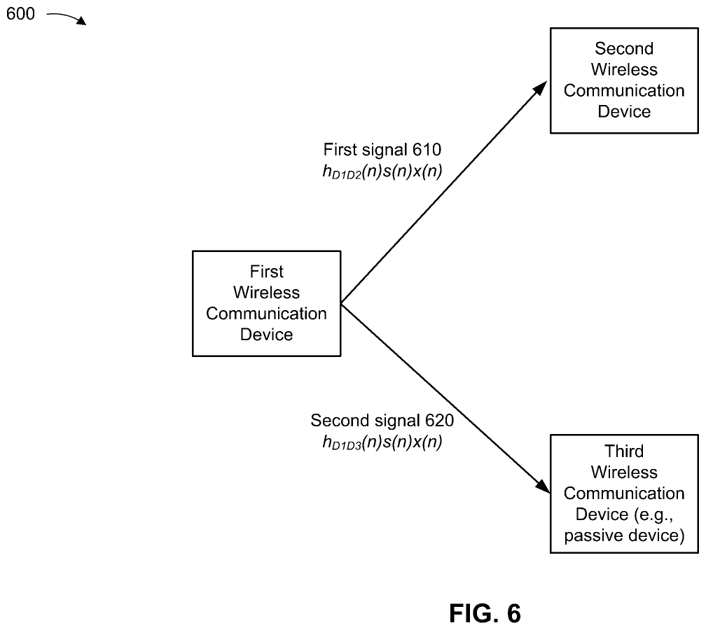

FIG. 6 is a diagram illustrating an example 600 of a first wireless communication device communicating with a second wireless communication device and a third wireless communication device (shown as a passive IoT device), in accordance with the present disclosure. The first wireless communication device may include a UE (e.g., UE 120) or a network entity (e.g., a base station 110 or one or more entities of a disaggregated base station, such as in FIG. 3). The second wireless communication device may include a UE (e.g., UE 120) or a network entity (e.g., a base station 110 or one or more entities of a disaggregated base station, such as in FIG. 3). In some aspects, the third wireless communication device may include a passive device (e.g., an ambient IoT device, a passive IoT device, a semi-passive IoT device, an LP-WUR, and/or a radio frequency identification (RFID) tag). In an uplink context, the first wireless communication device may comprise a UE and the second wireless communication device may comprise a network entity. In a downlink context, the first wireless communication device may comprise a network entity and the second wireless communication device may comprise a UE. In the sidelink context, the first wireless communication device may comprise a UE and the second wireless communication device may comprise a UE.

A network entity or UE operating in a wireless communication system may be configured to read information from and/or write information to the third wireless communication device. The third wireless communication device may be a passive device, as mentioned above. An active device and/or active component (e.g., a semiconductor device, a voltage source, and/or an operational amplifier) may add and/or transfer energy into a circuit. A passive device and/or passive component (e.g., a resistor, a capacitor, and/or a diode) may store and/or consume energy. Accordingly, in some aspects, “passive device” may denote a device without an external energy source and/or a device configured to use environmental energy for an energy supply.

In some aspects, the third wireless communication device includes an electronic circuit to convert energy from an input signal received via an antenna to an energy source for one or more components included in the third wireless communication device. For example, a power harvesting component may include a diode that is electrically coupled to a capacitor. The power harvesting component may receive the input signal using an antenna and/or an impedance matching circuit. The power harvesting component may electrically couple to a regulator component that outputs a fixed voltage for powering a microcontroller unit. As one example, the regulator component may convert an input alternating current (AC) signal to a direct current (DC) signal. The microcontroller unit may process input from a demodulator component (e.g., that demodulates the input signal) and/or one or more sensors. In some aspects, the microcontroller unit may generate an output that is input to a modulator component and transmitted by the third wireless communication device to the network node. In some aspects, a third wireless communication device implemented as a passive IoT device and/or a passive RFID may include a diode, a capacitor, a resistor, and a switch to generate a backscatter signal (e.g., a reflected signal) that includes modulated information. A “semi-passive” device (e.g., a semi-passive IoT device) may include a battery that is charged by the device based at least in part on the (converted) environmental energy.

It should be noted that the third wireless communication device can include an active device, which may be capable of generating a signal without using energy harvesting, such as using stored energy. An active device can include an LP-WUR.

As shown, the first wireless communication device may transmit a first signal 610 to the second wireless communication device. The first signal 610 may carry data (e.g., a payload) for the second wireless communication device (denoted as x(n)). As further shown, the first wireless communication device may transmit a second signal 620 to the third wireless communication device. The second signal 620 may include a modulated signal carrying data for the third wireless communication device. The data for the third wireless communication device is denoted as s(n). In some examples, the modulated signal may be a continuous wave signal.

In example 600, the first signal 610 and the second signal 620 both carry the data for the third wireless communication device, as indicated by s(n)x(n) illustrated with regard to the first signal 610 and the second signal 620. For example, the first wireless communication device may simultaneously transmit the data for the third wireless communication device to the second wireless communication device and the third wireless communication device, thereby achieving improved utilization of the spectrum relative to transmitting the first signal 610 and the second signal 620 separately from one another. Furthermore, the first signal 610 propagates via a channel h_{DID2}(n) between the first wireless communication device and the second wireless communication device, and the second signal 620 propagates via a channel h_{DID3}(n) between the first wireless communication device and the third wireless communication device.

The second wireless communication device may need to decode x(n) to obtain the data for the second wireless communication device. However, the first signal 610 is modulated with the data for the third wireless communication device (s(n)) since the same signal is transmitted to the second wireless communication device and the third wireless communication device. For example, x(n) may be modulated by s(n) using any suitable modulation scheme (e.g., amplitude shift keying (ASK), phase shift keying (PSK), frequency shift keying (FSK), OOK, or the like). Signal generation may include modulating sub-carriers of OFDM symbols. For example, OOK may include ASK with part or all of the OFDM symbol multiplied/masked by/with zero or modulating sub-carriers of OFDM symbols to result in a Manchester coding in time domain, such as by an OFDM waveform generator. Some techniques described herein provide signaling to the second wireless communication device, such as in advance of the transmission of the first signal 610 and the second signal 620, of the data for the third wireless communication device (e.g., s(n)). Thus, the second wireless communication device can use the data for the third wireless communication device to decode the first signal 610, such as by canceling the modulated data for the third wireless communication device from the first signal 610. For example, the second wireless communication device may divide the received first signal 610 by s(n) (in the case of ASK or PSK) or may decode x(n) using knowledge of s(n).

In some examples, s(n) may include an OOK modulated signal with Manchester coding within a single OFDM symbol. The first wireless communication device may activate or deactivate the OFDM waveform generator generate an on-off pattern across multiple OFDM symbols. For example, a first OFDM symbol may be “on” (as caused by an active OFDM waveform generator) and a second OFDM symbol may be “off” (as caused by an inactive OFDM waveform generator). Thus, data of “10” can be conveyed. In some aspects, the first wireless communication device may cancel (e.g., set to zero, zero out, blank, mute) a part of an OFDM symbol in the time domain, which may generate an on-off pattern within an OFDM symbol. Manchester code (also known as phase encoding, or PE) is a line code in which the encoding of each data bit is either low then high, or high then low, for equal time. For example, a value of 0 may be indicated by an ON->OFF encoding, and a value of 1 may be indicated by an OFF->ON encoding. Manchester coding may eliminate the need to estimate detector threshold in the receiver thereby simplifying receiver design, may provide increased robustness against interference (e.g., due to no bias) relative to OOK, and may include an equal number of 0s and is.

Due to the properties of the FFT and the discrete Fourier transform (DFT), a frequency-domain comb structure may create time-domain repetitions. For example, for a comb-2 structure in frequency (e.g., every other tone being set to zero), the combination of signals may include [x,x] or [y,−y], depending on whether the signal is transmitted on the odd subcarriers or on the even subcarriers. Thus, two values can be indicated. Similarly, a comb-K structure in the frequency domain may create K repetitions in the time domain.

As indicated above, FIG. 6 is provided as an example. Other examples may differ from what is described with regard to FIG. 6.

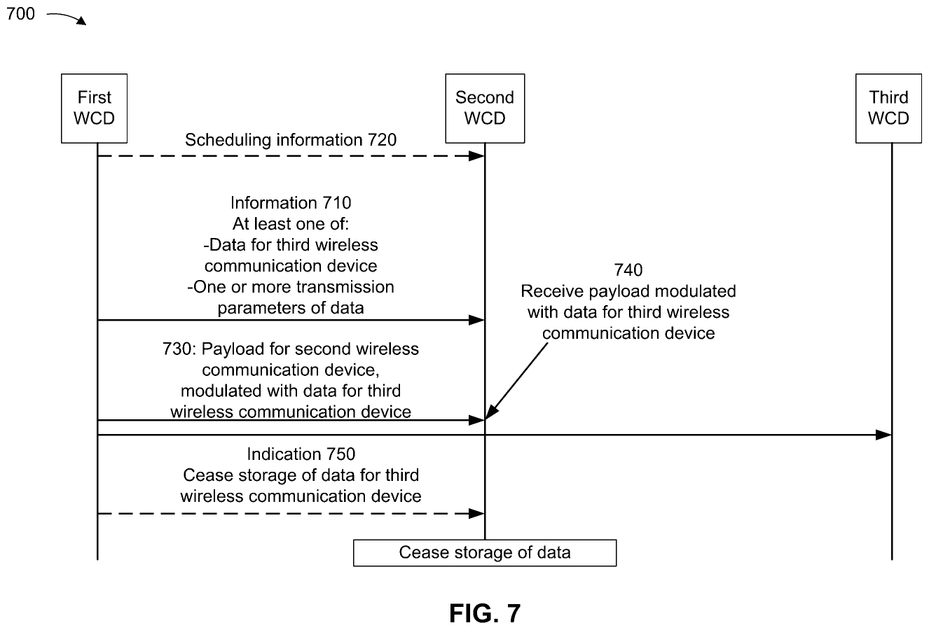

FIG. 7 is a diagram illustrating an example 700 of signaling associated with indication of a passive device data transmission to a wireless communication device, in accordance with the present disclosure. As shown, example 700 includes a first wireless communication device communicating with a second wireless communication device and a third wireless communication device (shown as a passive IoT device), in accordance with the present disclosure. The first wireless communication device may include a UE (e.g., UE 120) or a network entity (e.g., a base station 110 or one or more entities of a disaggregated base station, such as in FIG. 3). The second wireless communication device may include a UE (e.g., UE 120) or a network entity (e.g., a base station 110 or one or more entities of a disaggregated base station, such as in FIG. 3). In some aspects, the third wireless communication device may include a passive device (e.g., an ambient IoT device, a passive IoT device, a semi-passive IoT device, an LP-WUR, and/or an RFID tag). In an uplink context, the first wireless communication device may comprise a UE and the second wireless communication device may comprise a network entity. In a downlink context, the first wireless communication device may comprise a network entity and the second wireless communication device may comprise a UE. In the sidelink context, the first wireless communication device may comprise a UE or a network entity that uses the sidelink/PC5 interface and the second wireless communication device may comprise a UE or a network entity that uses the sidelink/PC5 interface.

As shown, the first wireless communication device may output (e.g., transmit or provide for transmission), and the second wireless communication device may receive, information 710 indicating at least one of data for the third wireless communication device, or one or more transmission parameters of the data for the third wireless communication device. For example, the information 710 may include the data for the third wireless communication device and/or the one or more transmission parameters. As another example, the information 710 may identify a configured value of the data or the one or more transmission parameters. The first wireless communication device may transmit the information 710 via DCI, a PDSCH (e.g., a short PDSCH such as a PDSCH in a short transmission time interval (STTI) mode), a MAC control element (CE) (MAC-CE), RRC signaling, a PSSCH, sidelink control information (SCI) (e.g., SCI-1 or SCI-2), or a combination thereof. MAC signaling (e.g., a MAC-CE) may be beneficial in situations where communications with the third wireless communication device have a long periodicity. RRC signaling may be beneficial in situations where communications with the third wireless communication device have a longer periodicity (e.g., longer than the periodicity for which MAC signaling is beneficial). DCI and short PDSCH based signaling may be beneficial for frequent communications with the second wireless communication device and the third wireless communication device.

In some aspects, the data for the third wireless communication device may include a sequence of bits. For example, the first wireless communication device may transmit a sequence 1101 to the third wireless communication device (e.g., an RFID tag) using ASK modulation, PSK modulation, or FSK modulation. The information 710 may indicate the sequence 1101, which may be referred to as the data for the third wireless communication device or a payload of the data for the third wireless communication device. As described below, the first wireless communication device may also transmit a payload to the second wireless communication device that includes (e.g., is modulated with, identifies, indicates) the data for the third wireless communication device. For example, the payload for the second wireless communication device may be transmitted via a PDSCH of which a number of OFDM symbols are modulated with the sequence 1101 (e.g., using OOK Manchester coding across the number of OFDM symbols or on each OFDM symbol or using ASK, PSK, or FSK modulation).

The one or more transmission parameters may include information that can be used by the second wireless communication device to receive the payload for the second wireless communication device, such as by canceling the data for the first wireless communication device that is modulated with the payload for the second wireless communication device. For example, the one or more transmission parameters may relate to or identify how the data for the third wireless communication device is modulated with the payload for the second wireless communication device (e.g., a modulation scheme), a waveform of the data for the third wireless communication device, a code rate of the data for the third wireless communication device, or the like. In some aspects, the one or more transmission parameters may identify an identifier of the third wireless communication device. In some aspects, the second wireless communication device may receive the one or more transmission parameters from a network entity, which may or may not be the first wireless communication device. Using the one or more transmission parameters, the second wireless communication device can remove the data for the third wireless communication device from the payload for the second wireless communication device. For example, the second wireless communication device may multiply the received signal by the conjugate and may divide over the signal square, or may divide over the data for the third wireless communication device (e.g., s(n)).

In some aspects, the one or more transmission parameters may be identified by a wireless communication specification. For example, the wireless communication specification may indicate one or more transmission parameters corresponding to a device class of the third wireless communication device, and the first wireless communication device (or a network entity) may provide an indication of the device class such that the second wireless communication device can identify the one or more transmission parameters.

In some aspects, the one or more transmission parameters may indicate an identifier of the third wireless communication device. For example, the identifier of the third wireless communication device may include a device identifier (e.g., a tag identifier). As another example, the one or more transmission parameters may include a HARQ identifier used to transmit the payload (e.g., a PDSCH carrying the payload) for the second wireless communication device or another PDSCH. As yet another example, the one or more transmission parameters may include a HARQ identifier of the third wireless communication device (e.g., a tag HARQ identifier).

In some aspects, the second wireless communication device may transmit, and the first wireless communication device may receive, capability information (not shown in FIG. 7 for brevity). The capability information may indicate a capability regarding the data for the third wireless communication device. For example, the capability information may indicate how long the second wireless communication device can store the data for the third wireless communication device (e.g., a maximum length of time between receiving the information 710 and the payload for the second wireless communication device). As another example, the capability information may indicate a number of third wireless communication devices for which the second wireless communication device can simultaneously store data. As yet another example, the capability information may indicate a set of transmission parameters (of transmission parameters that can be used to transmit the data for the third wireless communication device) supported by the second wireless communication device. As another example, the capability information may indicate whether the second wireless communication device can decode the payload for the second wireless communication device without having received the data for the third wireless communication device, as described below.

As shown by reference number 720, in some examples, the first wireless communication device may transmit, and the second wireless communication device may receive, scheduling information. The scheduling information may indicate the transmission of the information 710 and the transmission of the payload for the second wireless communication device (which is modulated with the data for the third wireless communication device). For example, the first wireless communication device may transmit DCI (e.g., a single DCI) scheduling a first transmission (e.g., a first PDSCH transmission) carrying the information 710 and a second transmission (e.g., a second PDSCH transmission) of the payload for the second wireless communication device and the data for the third wireless communication device.

In some aspects, the scheduling information may indicate one or more slot offsets, such as a slot offset between the scheduling information (e.g., a slot in which a PDCCH or PSCCH communication carrying the scheduling information is transmitted or received) and reception of the first transmission carrying the information 710 (e.g., a first KG slot offset), a slot offset between the scheduling information (e.g., a slot in which a PDCCH or PSCCH communication carrying the scheduling information is transmitted or received) and reception of the second transmission carrying the payload for the second wireless communication device (e.g., a second KG slot offset), a slot offset between the reception of the first transmission carrying the information 710 and a feedback resource for the first transmission occurring prior to the second transmission (e.g., a first K1 slot offset), a slot offset between the reception of the second transmission and a feedback resource for the second transmission (and optionally also for the first transmission) (e.g., a second K1 slot offset), or the like. In some aspects, the scheduling information may indicate a slot offset between the first transmission and the second transmission.

As mentioned above, in some aspects, the scheduling information may indicate a feedback resource that occurs prior to the transmission of the payload for the second wireless communication device (e.g., the second transmission mentioned above). Thus, the second wireless communication device can transmit first feedback regarding the information 710. Furthermore the scheduling information may indicate a feedback resource that occurs after the transmission of the payload for the second wireless communication device. Thus, the second wireless communication device can transmit second feedback regarding the payload for the second wireless communication device. In some aspects, the first wireless communication device may transmit the payload for the second wireless communication device based at least in part on the first feedback. For example, the first wireless communication device may transmit the payload only if the first feedback indicates that the information 710 was successfully received, thereby reducing overhead relative to if the payload is transmitted independently of whether the information 710 is received.

In some aspects, a feedback resource for the transmission of the information 710 (e.g., the first transmission) and the transmission of the payload for the second wireless communication device may occur after the transmission of the payload. For example, the feedback resource may include a single feedback resource and feedback transmitted on the single feedback resource may include a two-bit ACK or NACK. As another example, the feedback resource may include a first resource and a second resource, and feedback regarding the first transmission and the second transmission may be transmitted on the first resource and the second resource, respectively.

In some aspects, the first wireless communication device may retransmit a communication based at least in part on feedback (e.g., first feedback, second feedback, or combined feedback regarding transmission of the information 710 and/or the transmission of the payload). For example, the first wireless communication device may retransmit (e.g., schedule retransmission of) only the information 710 if the information 710 was not successfully received, such that the second wireless communication device can reattempt decoding of the payload. As another example, the first wireless communication device may retransmit (e.g., schedule retransmission of) both the information 710 and the payload. As yet another example, the first wireless communication device may retransmit (e.g., schedule retransmission of) only the payload, for example, if the information 710 was successfully received.

As shown by reference number 730, the first wireless communication device may transmit, and the second wireless communication device and the third wireless communication device may receive, the payload for the second wireless communication device. Furthermore, the payload for the second wireless communication device may be modulated with the data for the third wireless communication device, as described above.

In some aspects, the data for the third wireless communication device may be multiplexed in a PDSCH or PSSCH carrying the payload. For example, the PDSCH may be encoded and modulated, and the data for the third wireless communication device may be modulated onto the encoded and modulated signal derived from the PDSCH. In some aspects, the data for the third wireless communication device may be encoded onto one or more REs or RBs of the PDSCH or the payload.

In some aspects, the first wireless communication device may provide an indication of a location of the data for the third wireless communication device in the payload (or a PDSCH or PSSCH carrying the payload). For example, the first wireless communication device may provide an indication of a start of the data, a length of the data (e.g., a number of OFDM symbols), or a combination of thereof, of the modulated (e.g., multiplexed, piggybacked) data for the third wireless communication device. If the data is transmitted across multiple slots, the first wireless communication device may provide a respective indication for each of the multiple slots.

In some aspects, the first wireless communication device may transmit the data for the third wireless communication device across multiple slots (e.g., in two or more slots). For example, a first part of the data may occur in a first slot and a second part of the data (which may be the same as or different than the first data) may occur in a second slot. In this example, in some aspects, the first wireless communication device may provide the information 710 in separate transmissions, where each transmission of the separate transmission is associated with a different slot of the multiple slots. Alternatively, the first wireless communication device may provide all information 710, for all of the multiple slots, in a single transmission.

In some aspects, the first wireless communication device may schedule transmission of the information 710. Scheduling information for the transmission of the information 710 may indicate an identifier of the data or of the third wireless communication device. The second wireless communication device may receive the information 710 if the identifier corresponds to a third wireless communication device for which the second wireless communication device's payload is modulated with data. The second wireless communication device may skip reception of the information 710 if the identifier corresponds to a third wireless communication device for which the second wireless communication device's payload is not modulated with data.

As shown by reference number 740, the second wireless communication device may receive the payload modulated with the data for the third wireless communication device. For example, the second wireless communication device may perform equalization or removal of the data from the payload in accordance with the information 710, as described elsewhere herein. The payload modulated with the data may be transmitted via a sidelink transmission, an uplink transmission, or a downlink transmission.

In some aspects, the second wireless communication device may determine the payload and the data for the third wireless communication device. For example, the second wireless communication device may jointly decode the payload and the data, such as using the one or more transmission parameters (e.g., without having received the data for the third wireless communication device). In some aspects, the one or more transmission parameters may indicate a codebook used to encode the data for the third wireless communication device, a modulation scheme of the data for the third wireless communication device, and a location of the data in the payload or the transmission of the payload. Thus, overhead associated with transmission of the data for the third wireless communication device as part of the information 710 is reduced. In some aspects, the second wireless communication device may determine the payload and the data using DMRS detection. For example, the second wireless communication device may determine a measurement (e.g., a reference signal received power (RSRP)) of a DMRS of a portion of an OFDM symbol, or per OFDM symbol, to determine the data for the third wireless communication device. The second wireless communication device may use a threshold (e.g., an RSRP threshold, a reference signal received quality (RSRQ) threshold, a signal to interference plus noise (SINR) threshold) to determine whether the data for the third wireless communication device is present in the transmission of the payload. The threshold may be configured with the first wireless communication device and/or a network entity. In some aspects, the threshold may be specific to a device class of the third wireless communication device or other information related to the third wireless communication device. In some aspects, the second wireless communication device may perform low-density parity check (LDPC) decoding on each hypothesis (e.g., each potential value of the data for the third wireless communication device).

In some aspects, the first wireless communication device may output, and the second wireless communication device may receive, an indication 750 for the second wireless communication device to cease storage of the data for the third wireless communication device. The second wireless communication device may cease storage of the data in accordance with the indication 750. For example, the first wireless communication device (or the third wireless communication device) may indicate for the second wireless communication device to flush the data for the third wireless communication device, which may be beneficial if the first wireless communication device determines that the third wireless communication device has received the data for the third wireless communication device because storage overhead of the second wireless communication device may be reduced. As another example, the second wireless communication device may receive signaling (such as an acknowledgment) of the data for the third wireless communication device from the third wireless communication device (which may comprise signaling from the third wireless communication device to the first wireless communication device), and the second wireless communication device may flush the data for the third wireless communication device according to the signaling, which may allow for flushing of the data without an explicit indication to the second wireless communication device.

As indicated above, FIG. 7 is provided as an example. Other examples may differ from what is described with regard to FIG. 7.

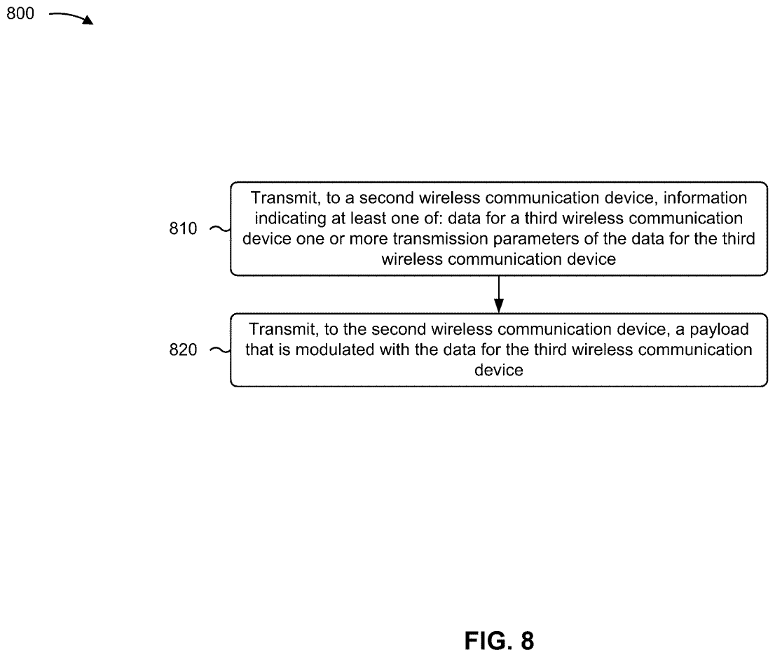

FIG. 8 shows a method 800 for wireless communications by a UE, such as UE 120.

Method 800 begins at 810 with transmitting, to a second wireless communication device, information indicating at least one of: data for a third wireless communication device, or one or more transmission parameters of the data for the third wireless communication device.

Method 800 then proceeds to step 820 with transmitting, to the second wireless communication device, a payload that is modulated with the data for the third wireless communication device.

In a first aspect, the third wireless communication device comprises a passive device.

In a second aspect, alone or in combination with the first aspect, transmitting the information further comprises transmitting the information via at least one of downlinking control information, a short physical downlink shared channel, a MAC-CE, or radio resource control signaling.

In a third aspect, alone or in combination with one or more of the first and second aspects, transmitting the information comprises transmitting the one or more transmission parameters of the data, and the one or more transmission parameters indicate at least one of a modulation scheme, a code rate, or a waveform of the data for the third wireless communication device.

In a fourth aspect, alone or in combination with one or more of the first through third aspects, the one or more transmission parameters include an identifier of the third wireless communication device.

In a fifth aspect, alone or in combination with one or more of the first through fourth aspects, method 800 includes transmitting the information based at least in part on the capability information.

In a sixth aspect, alone or in combination with one or more of the first through fifth aspects, method 800 includes transmitting an indication for the second wireless communication device to cease storage of the data for the third wireless communication device.

In a seventh aspect, alone or in combination with one or more of the first through sixth aspects, method 800 includes transmitting scheduling information indicating the transmission of the information and the transmission of the payload.

In an eighth aspect, alone or in combination with one or more of the first through seventh aspects, transmitting the scheduling information occurs prior to transmitting the information, and the scheduling information indicates one or more offsets for feedback regarding the information or for feedback regarding the payload.

In a ninth aspect, alone or in combination with one or more of the first through eighth aspects, method 800 includes transmitting the payload based at least in part on the feedback.

In a tenth aspect, alone or in combination with one or more of the first through ninth aspects, method 800 includes receiving first feedback regarding the information and second feedback regarding the payload.

In an eleventh aspect, alone or in combination with one or more of the first through tenth aspects, transmitting the information further comprises multiplexing the information in a physical downlink shared channel.

In a twelfth aspect, alone or in combination with one or more of the first through eleventh aspects, transmitting the payload further comprises multiplexing the data for the third wireless communication device in a physical downlink shared channel carrying the payload.

In a thirteenth aspect, alone or in combination with one or more of the first through twelfth aspects, transmitting the information comprises transmitting the one or more transmission parameters of the data, and the one or more transmission parameters indicate a location of the data in the payload.

In a fourteenth aspect, alone or in combination with one or more of the first through thirteenth aspects, the transmission of the payload that is modulated with the data spans multiple slots, and the transmission of the information comprises a single transmission.

In a fifteenth aspect, alone or in combination with one or more of the first through fourteenth aspects, the transmission of the payload that is modulated with the data spans multiple slots, and the transmission of the information comprises multiple transmissions corresponding to the multiple slots.

In a sixteenth aspect, alone or in combination with one or more of the first through fifteenth aspects, the one or more transmission parameters indicate at least one of a codebook associated with the data, a modulation scheme associated with the data, a location of the data in the payload, whether the data is present in the payload, or a combination thereof.

In a seventeenth aspect, alone or in combination with one or more of the first through sixteenth aspects, the transmission of the payload is a sidelink transmission.

In an eighteenth aspect, alone or in combination with one or more of the first through seventeenth aspects, the transmission of the payload is an uplink transmission.

In a nineteenth aspect, alone or in combination with one or more of the first through eighteenth aspects, the transmission of the payload is a downlink transmission.

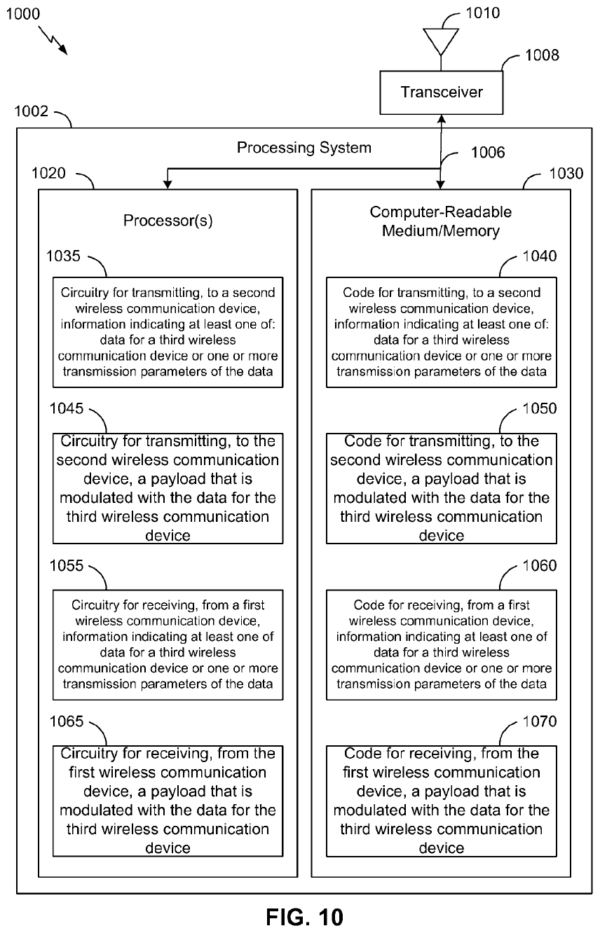

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

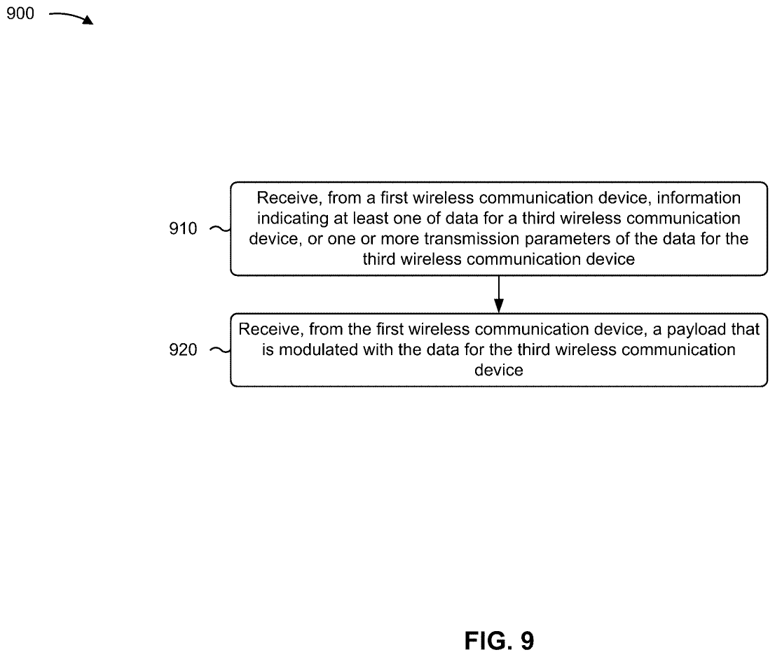

FIG. 9 shows a method 900 for wireless communications by a UE, such as UE 120.

Method 900 begins at 910 with receiving, from a first wireless communication device, information indicating at least one of: data for a third wireless communication device, or one or more transmission parameters of the data for the third wireless communication device.

Method 900 then proceeds to step 920 with receiving, from the first wireless communication device, a payload that is modulated with the data for the third wireless communication device.

In a first aspect, receiving the payload further comprises performing equalization or removal of the data for the third wireless communication device from the payload in accordance with the information.

In a second aspect, alone or in combination with the first aspect, the third wireless communication device comprises a passive Internet of Things device.

In a third aspect, alone or in combination with one or more of the first and second aspects, receiving the information further comprises receiving the information via at least one of downlinking control information, a short physical downlink shared channel, a medium access control control element, or radio resource control signaling.

In a fourth aspect, alone or in combination with one or more of the first through third aspects, receiving the information comprises receiving the one or more transmission parameters of the data, and the one or more transmission parameters indicate at least one of a modulation scheme, a code rate, or a waveform of the data for the third wireless communication device.

In a fifth aspect, alone or in combination with one or more of the first through fourth aspects, the one or more transmission parameters include an identifier of the third wireless communication device.

In a sixth aspect, alone or in combination with one or more of the first through fifth aspects, method 900 includes receiving the information based at least in part on the capability information.

In a seventh aspect, alone or in combination with one or more of the first through sixth aspects, method 900 includes receiving an indication to cease storage of the data for the third wireless communication device, and ceasing storage of the data for the third wireless communication device.

In an eighth aspect, alone or in combination with one or more of the first through seventh aspects, method 900 includes receiving scheduling information indicating the transmission of the information and the transmission of the payload.

In a ninth aspect, alone or in combination with one or more of the first through eighth aspects, receiving the scheduling information occurs prior to receiving the information, and the scheduling information indicates one or more offsets for feedback regarding the information or feedback regarding the payload.

In a tenth aspect, alone or in combination with one or more of the first through ninth aspects, method 900 includes receiving the payload based at least in part on the feedback.

In an eleventh aspect, alone or in combination with one or more of the first through tenth aspects, method 900 includes transmitting first feedback regarding the information and second feedback regarding the payload.

In a twelfth aspect, alone or in combination with one or more of the first through eleventh aspects, receiving the information further comprises receiving the information multiplexed in a physical downlink shared channel.

In a thirteenth aspect, alone or in combination with one or more of the first through twelfth aspects, receiving the payload further comprises the receiving the data for the third wireless communication device multiplexed in a physical downlink shared channel carrying the payload.

In a fourteenth aspect, alone or in combination with one or more of the first through thirteenth aspects, receiving the information comprises receiving the one or more transmission parameters of the data, and the one or more transmission parameters indicate a location of the data in the payload.

In a fifteenth aspect, alone or in combination with one or more of the first through fourteenth aspects, the transmission of the payload that is modulated with the data spans multiple slots, and the transmission of the information comprises a single transmission.

In a sixteenth aspect, alone or in combination with one or more of the first through fifteenth aspects, the transmission of the payload that is modulated with the data spans multiple slots, and the transmission of the information comprises multiple transmissions corresponding to the multiple slots.

In a seventeenth aspect, alone or in combination with one or more of the first through sixteenth aspects, the one or more transmission parameters indicate at least one of a codebook associated with the data, a modulation scheme associated with the data, a location of the data in the payload, whether the data is present in the payload, or a combination thereof, and receiving the payload further comprises performing blind decoding in accordance with the one or more transmission parameters.

In an eighteenth aspect, alone or in combination with one or more of the first through seventeenth aspects, the reception of the payload is a sidelink reception.

In a nineteenth aspect, alone or in combination with one or more of the first through eighteenth aspects, the reception of the payload is an uplink reception.

In a twentieth aspect, alone or in combination with one or more of the first through nineteenth aspects, the reception of the payload is a downlink reception.

In one aspect, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative steps are possible consistent with this disclosure.

FIG. 10 is a diagram illustrating an example of an implementation of code and circuitry for a communications device 1000, in accordance with the present disclosure. The communications device 1000 may be a wireless communication device (e.g., a UE 120, a BS 110, or one or more components of a disaggregated base station), or a wireless communication device may include the communications device 1000.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of one or more of receive processor 258, transmit processor 264, TX MIMO processor 266, and/or controller/processor 280, as described with respect to FIG. 2. The one or more processors 1020 are coupled to a computer-readable medium/memory 1030 via a bus 1006. In various aspects, the computer-readable medium/memory 1030 may be representative of memory 282, as described with respect to FIG. 2. In certain aspects, the computer-readable medium/memory 1030 is configured to store instructions (e.g., computer-executable code, processor-executable code) that when executed by the one or more processors 1020, cause the one or more processors 1020 to perform the method 800 described with respect to FIG. 8, the method 900 described with respect to FIG. 9, or any aspect related to these methods. Note that reference to a processor performing a function of communications device 1000 may include one or more processors performing that function of communications device 1000.

As shown in FIG. 10, the communications device 1000 may include circuitry for transmitting, to a second wireless communication device, information indicating at least one of data for a third wireless communication device or one or more transmission parameters of the data (circuitry 1035).

As shown in FIG. 10, the communications device 1000 may include, stored in computer-readable medium/memory 1030, code for transmitting, to a second wireless communication device, information indicating at least one of: data for a third wireless communication device or one or more transmission parameters of the data (code 1040).

As shown in FIG. 10, the communications device 1000 may include circuitry for transmitting, to the second wireless communication device, a payload that is modulated with the data for the third wireless communication device (circuitry 1045).

As shown in FIG. 10, the communications device 1000 may include, stored in computer-readable medium/memory 1030, code for transmitting, to the second wireless communication device, a payload that is modulated with the data for the third wireless communication device (code 1050).

As shown in FIG. 10, the communications device 1000 may include circuitry for receiving, from a first wireless communication device, information indicating at least one of data for a third wireless communication device or one or more transmission parameters of the data (circuitry 1055).

As shown in FIG. 10, the communications device 1000 may include, stored in computer-readable medium/memory 1030, code for receiving, from a first wireless communication device, information indicating at least one of data for a third wireless communication device or one or more transmission parameters of the data (code 1060).

As shown in FIG. 10, the communications device 1000 may include circuitry for receiving, from the first wireless communication device, a payload that is modulated with the data for the third wireless communication device (circuitry 1065).

As shown in FIG. 10, the communications device 1000 may include, stored in computer-readable medium/memory 1030, code for receiving, from the first wireless communication device, a payload that is modulated with the data for the third wireless communication device (code 1070).

Various components of the communications device 1000 may provide means for performing the method 800 described with respect to FIG. 8, the method 900 described with respect to FIG. 9, or any aspect related to these methods. For example, means for transmitting, sending, or outputting for transmission may include the transceiver(s) 254 and/or antenna(s) 252 of the UE 120 and/or transceiver 1008 and antenna 1010 of the communications device 1000 in FIG. 10. Means for receiving or obtaining may include the transceiver(s) 254 and/or antenna(s) 252 of the UE 120 and/or transceiver 1008 and antenna 1010 of the communications device 1000 in FIG. 10.

FIG. 10 is provided as an example. Other examples may differ from what is described in connection with FIG. 10.

The following provides an overview of some Aspects of the present disclosure:

Aspect 1: A method of wireless communication performed by a first wireless communication device, comprising: transmitting, to a second wireless communication device, information indicating at least one of: data for a third wireless communication device, or one or more transmission parameters of the data for the third wireless communication device; and transmitting, to the second wireless communication device, a payload that is modulated with the data for the third wireless communication device.

Aspect 2: The method of Aspect 1, wherein the third wireless communication device comprises a passive Internet of Things device.

Aspect 3: The method of any of Aspects 1-2, wherein transmitting the information further comprises transmitting the information via at least one of: downlink control information, a short physical downlink shared channel, a medium access control (MAC) control element (CE), or radio resource control signaling.

Aspect 4: The method of any of Aspects 1-3, wherein transmitting the information comprises transmitting the one or more transmission parameters of the data, and wherein the one or more transmission parameters indicate at least one of a modulation scheme, a code rate, or a waveform of the data for the third wireless communication device.

Aspect 5: The method of any of Aspects 1-4, wherein the one or more transmission parameters include an identifier of the third wireless communication device.

Aspect 6: The method of any of Aspects 1-5, further comprising receiving, from the second wireless communication device, capability information indicating a capability regarding the data for the third wireless communication device, wherein transmitting the information further comprises transmitting the information based at least in part on the capability information.

Aspect 7: The method of any of Aspects 1-6, further comprising transmitting an indication for the second wireless communication device to cease storage of the data for the third wireless communication device.

Aspect 8: The method of any of Aspects 1-7, further comprising transmitting scheduling information indicating the transmission of the information and the transmission of the payload.

Aspect 9: The method of Aspect 8, wherein transmitting the scheduling information occurs prior to transmitting the information, and wherein the scheduling information indicates one or more offsets for feedback regarding the information or for feedback regarding the payload.

Aspect 10: The method of any of Aspects 1-9, further comprising receiving, prior to transmitting the payload, feedback regarding the transmission of the information, wherein transmitting the payload further comprises transmitting the payload based at least in part on the feedback.

Aspect 11: The method of any of Aspects 1-10, further comprising receiving first feedback regarding the information and second feedback regarding the payload.

Aspect 12: The method of any of Aspects 1-11, wherein transmitting the information further comprises multiplexing the information in a physical downlink shared channel.

Aspect 13: The method of any of Aspects 1-12, wherein transmitting the payload further comprises multiplexing the data for the third wireless communication device in a physical downlink shared channel carrying the payload.

Aspect 14: The method of any of Aspects 1-13, wherein transmitting the information comprises transmitting the one or more transmission parameters of the data, and wherein the one or more transmission parameters indicate a location of the data in the payload.

Aspect 15: The method of any of Aspects 1-14, wherein the transmission of the payload that is modulated with the data spans multiple slots, and wherein the transmission of the information comprises a single transmission.

Aspect 16: The method of any of Aspects 1-15, wherein the transmission of the payload that is modulated with the data spans multiple slots, and wherein the transmission of the information comprises multiple transmissions corresponding to the multiple slots.

Aspect 17: The method of any of Aspects 1-16, wherein the one or more transmission parameters indicate at least one of: a codebook associated with the data, a modulation scheme associated with the data, a location of the data in the payload, whether the data is present in the payload, or a combination thereof.

Aspect 18: The method of any of Aspects 1-17, wherein the transmission of the payload is a sidelink transmission.

Aspect 19: The method of any of Aspects 1-18, wherein the transmission of the payload is an uplink transmission.

Aspect 20: The method of any of Aspects 1-19, wherein the transmission of the payload is a downlink transmission.

Aspect 21: A method of wireless communication performed by a second wireless communication device, comprising: receiving, from a first wireless communication device, information indicating at least one of: data for a third wireless communication device, or one or more transmission parameters of the data for the third wireless communication device; and receiving, from the first wireless communication device, a payload that is modulated with the data for the third wireless communication device.

Aspect 22: The method of Aspect 21, wherein receiving the payload further comprises performing equalization or removal of the data for the third wireless communication device from the payload in accordance with the information.

Aspect 23: The method of any of Aspects 21-22, wherein the third wireless communication device comprises a passive Internet of Things device.

Aspect 24: The method of any of Aspects 21-23, wherein receiving the information further comprises receiving the information via at least one of: downlink control information, a short physical downlink shared channel, a medium access control control element, or radio resource control signaling.

Aspect 25: The method of any of Aspects 21-24, wherein receiving the information comprises receiving the one or more transmission parameters of the data, and wherein the one or more transmission parameters indicate at least one of a modulation scheme, a code rate, or a waveform of the data for the third wireless communication device.

Aspect 26: The method of any of Aspects 21-25, wherein the one or more transmission parameters include an identifier of the third wireless communication device.

Aspect 27: The method of any of Aspects 21-26, further comprising transmitting capability information indicating a capability regarding the data for the third wireless communication device, wherein receiving the information further comprises receiving the information based at least in part on the capability information.

Aspect 28: The method of any of Aspects 21-27, further comprising receiving an indication to cease storage of the data for the third wireless communication device; and ceasing storage of the data for the third wireless communication device.

Aspect 29: The method of any of Aspects 21-28, further comprising receiving scheduling information indicating the transmission of the information and the transmission of the payload.

Aspect 30: The method of Aspect 29, wherein receiving the scheduling information occurs prior to receiving the information, and wherein the scheduling information indicates one or more offsets for feedback regarding the information or feedback regarding the payload.

Aspect 31: The method of any of Aspects 21-30, further comprising transmitting, prior to transmitting the payload, feedback regarding the transmission of the information, wherein receiving the payload further comprises receiving the payload based at least in part on the feedback.

Aspect 32: The method of any of Aspects 21-31, further comprising transmitting first feedback regarding the information and second feedback regarding the payload.

Aspect 33: The method of any of Aspects 21-32, wherein receiving the information further comprises receiving the information multiplexed in a physical downlink shared channel.

Aspect 34: The method of any of Aspects 21-33, wherein receiving the payload further comprises the receiving the data for the third wireless communication device multiplexed in a physical downlink shared channel carrying the payload.

Aspect 35: The method of any of Aspects 21-34, wherein receiving the information comprises receiving the one or more transmission parameters of the data, and the one or more transmission parameters indicate a location of the data in the payload.

Aspect 36: The method of any of Aspects 21-35, wherein the transmission of the payload that is modulated with the data spans multiple slots, and wherein the transmission of the information comprises a single transmission.

Aspect 37: The method of any of Aspects 21-36, wherein the transmission of the payload that is modulated with the data spans multiple slots, and wherein the transmission of the information comprises multiple transmissions corresponding to the multiple slots.

Aspect 38: The method of any of Aspects 21-37, wherein the one or more transmission parameters indicate at least one of: a codebook associated with the data, a modulation scheme associated with the data, a location of the data in the payload, whether the data is present in the payload, or a combination thereof, and wherein receiving the payload further comprises performing blind decoding in accordance with the one or more transmission parameters.

Aspect 39: The method of any of Aspects 21-38, wherein the reception of the payload is a sidelink reception.

Aspect 40: The method of any of Aspects 21-39, wherein the reception of the payload is an uplink reception.

Aspect 41: The method of any of Aspects 21-40, wherein the reception of the payload is a downlink reception.

Aspect 42: An apparatus for wireless communication at a device, comprising a processor; memory coupled with the processor; and instructions stored in the memory and executable by the processor to cause the apparatus to perform the method of one or more of Aspects 1-41.

Aspect 43: A device for wireless communication, comprising a memory and one or more processors coupled to the memory, the one or more processors configured to perform the method of one or more of Aspects 1-41.

Aspect 44: An apparatus for wireless communication, comprising at least one means for performing the method of one or more of Aspects 1-41.

Aspect 45: A non-transitory computer-readable medium storing code for wireless communication, the code comprising instructions executable by a processor to perform the method of one or more of Aspects 1-41.

Aspect 46: A non-transitory computer-readable medium storing a set of instructions for wireless communication, the set of instructions comprising one or more instructions that, when executed by one or more processors of a device, cause the device to perform the method of one or more of Aspects 1-41.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A first wireless communication device for wireless communication, comprising:
a memory; and
one or more processors, coupled to the memory, configured to:
transmit, to a second wireless communication device, information indicating at least one of: data for a third wireless communication device, or
one or more transmission parameters of the data for the third wireless communication device; and
transmit, to the second wireless communication device, a payload that is modulated with the data for the third wireless communication device.

2. The first wireless communication device of claim 1, wherein the third wireless communication device comprises a passive Internet of Things device.

3. The first wireless communication device of claim 1, wherein the one or more processors, to transmit the information, are configured to transmit the one or more transmission parameters of the data, and wherein the one or more transmission parameters indicate at least one of a modulation scheme, a code rate, or a waveform of the data for the third wireless communication device.

4. The first wireless communication device of claim 1, wherein the one or more transmission parameters include an identifier of the third wireless communication device.

5. The first wireless communication device of claim 1, wherein the one or more processors are further configured to receive, from the second wireless communication device, capability information indicating a capability regarding the data for the third wireless communication device, wherein the one or more processors, to transmit the information, are further configured to transmit the information based at least in part on the capability information.

6. The first wireless communication device of claim 1, wherein the one or more processors are further configured to transmit an indication for the second wireless communication device to cease storage of the data for the third wireless communication device.

7. The first wireless communication device of claim 1, wherein the one or more processors are further configured to transmit scheduling information indicating the transmission of the information and the transmission of the payload.

8. The first wireless communication device of claim 7, wherein the one or more processors are further configured to receive, prior to transmitting the payload, feedback regarding the transmission of the information, wherein, to transmit the payload, the one or more processors are further configured to transmit the payload based at least in part on the feedback.

9. The first wireless communication device of claim 1, wherein the one or more processors are further configured to receive first feedback regarding the information and second feedback regarding the payload.

10. The first wireless communication device of claim 1, wherein the one or more processors, to transmit the information, are configured to multiplex the information in a physical downlink shared channel.

11. The first wireless communication device of claim 1, wherein the one or more processors, to transmit the payload, are configured to multiplex the data for the third wireless communication device in a physical downlink shared channel carrying the payload.

12. The first wireless communication device of claim 1, wherein, to transmit the information, the one or more processors are configured to transmit the one or more transmission parameters of the data, and wherein the one or more transmission parameters indicate a location of the data in the payload.

13. The first wireless communication device of claim 1, wherein the transmission of the payload that is modulated with the data spans multiple slots, and wherein the transmission of the information comprises a single transmission.

14. The first wireless communication device of claim 1, wherein the transmission of the payload that is modulated with the data spans multiple slots, and wherein the transmission of the information comprises multiple transmissions corresponding to the multiple slots.

15. The first wireless communication device of claim 1, wherein the one or more transmission parameters indicate at least one of:
a codebook associated with the data,
a modulation scheme associated with the data,
a location of the data in the payload,
whether the data is present in the payload, or
a combination thereof.

16. A second wireless communication device for wireless communication, comprising:
a memory; and
one or more processors, coupled to the memory, configured to:
receive, from a first wireless communication device, information indicating at least one of:
data for a third wireless communication device, or
one or more transmission parameters of the data for the third wireless communication device; and
receive, from the first wireless communication device, a payload that is modulated with the data for the third wireless communication device.

17. The second wireless communication device of claim 16, wherein the one or more processors, to receive the payload, are configured to perform equalization or removal of the data for the third wireless communication device from the payload in accordance with the information.

18. The second wireless communication device of claim 16, wherein the one or more processors, to receive the information, are configured to receive the one or more transmission parameters of the data, and wherein the one or more transmission parameters indicate at least one of a modulation scheme, a code rate, or a waveform of the data for the third wireless communication device.

19. The second wireless communication device of claim 16, wherein the one or more transmission parameters include an identifier of the third wireless communication device.

20-28. (canceled)

29. A method of wireless communication performed by a first wireless communication device, comprising:
transmitting, to a second wireless communication device, information indicating at least one of: data for a third wireless communication device, or
one or more transmission parameters of the data for the third wireless communication device; and
transmitting, to the second wireless communication device, a payload that is modulated with the data for the third wireless communication device.

30. (canceled)
